(19) United States
(12) Patent Application Publication
(10) Pub. No.: US 2010/0078959 A1
(43) Pub. Date: Apr. 1, 2010

(54) UTILITY TRAILER COVER AND METHODS OF USE THEREOF

(76) Inventor: Chris Goodson, Jasper, GA (US)

Correspondence Address: Innovative IP, LLC, P.O. Box 217, New Smyrna Beach, FL, 32170, US

(21) Appl. No.: 12/570,113

(22) Filed: Sep. 30, 2009

Related U.S. Application Data
(60) Provisional application No. 61/101,839, filed on Oct. 1, 2008.

(51) Int. Cl. B62D 25/00

(52) U.S. Cl. 296/136.07

(57) ABSTRACT

A cover for an enclosed utility trailer, such as a PACE trailer, wherein deployment of the cover serves to deter tire rot by extending over the trailer wheels, serves to discourage unsightly peeling of applied commercial lettering, and serves to prevent the formation of unsightly and difficult to remove black streaks that otherwise frequently form on the personal cargo compartment during exposed trailer storage, and wherein the cover is designed to accommodate trailers of a plurality of lengths and dimensional configurations.

### CROSS-REFERENCE TO RELATED APPLICATION

The present U.S. Non-Provisional patent application claims priority to and all benefit of United States Provisional patent application entitled “Utility Trailer Cover and Methods of User Thereof,” filed on Oct. 1, 2008, on behalf of inventor Chris Goodson, and having assigned Ser. No. 61/101,839.

### FIELD

The present disclosure relates generally to vehicle cover devices, and more particularly, to an utility trailer cover and methods of use thereof.

### BACKGROUND

It is well known that prolonged exposure to the elements can be damaging. Heat, rain, wind, and the like can cause premature failure of structures and devices formed from wood, plastics, rubbers, fabrics, and even metals. Additionally, direct sunlight can destroy exposed finishes and foster corrosion. Even vehicles essentially intended and engineered for continual outdoor use are subject to damage from exposure, especially when parked during periods of non-use.

Many types of covers have been described in order to provide some measure of protection from the elements. Common issues render these designs disadvantageous depending upon the application, however. For example, protective covers have been described for automobiles, wherein essentially customized configuration to the particular body size and shape of the car facilitates a generally tight fit. These types of covers can be disadvantageously difficult to install given their tight engagement about the contours of the car, are each only suitable for use on one specific body style of automobile, and are typically fairly costly. Other more economical, somewhat generic covers are also described, wherein one of a plurality of automobile makes may be covered therewith. Such more generally shaped covers are more loose-fitting and can be simpler to deploy, however, windy conditions can sometimes result in unintended lifting and exposure of some, or all, of the vehicle.

For non-automobile vehicles, such as trucks, campers, motorcycles and boats, similar options for storage covers have been described, each with at least the same disadvantages. Moreover, none is structurally suitable or adaptable to effectively cover a personal utility trailer. That is, as an increasing population continues to expand the market for enclosed utility trailers for personal and small business use, so increases the need for an effective means of protected storage for such towable cargo haulers, especially because of their inherent tendency to be parked for generally extended periods of non-use.

Therefore, it is readily apparent that there is a need for a cover that is particularly suited for use on a personal size utility trailer, that can effectively accommodate and protect a plurality of structural features for such a trailer, that is easy to deploy, that is strong and effective for long-term use, and that is adapted for economical manufacture and sale, thereby avoiding the above-discussed disadvantages.

### BRIEF SUMMARY

Briefly described, in a preferred embodiment, the present utility trailer cover, and methods of use thereof, overcomes the above-mentioned disadvantages and meets the recognized need for such a device by providing a cargo trailer cover that is maximized for both aesthetic appearance and functionality, that is adapted for providing complete elemental protection, that allows for interior access to trailer contents, as desired, and that is coincidentally aesthetically pleasing and complementary to an on-trailer billboard advertisement, such as a logo, slogan or image.

According to its major aspects and broadly stated, in its preferred form, the present device is a cover for an enclosed utility trailer, such as a PACE trailer, wherein deployment of the cover serves to deter tire rot by extending over the trailer wheels, serves to discourage unsightly peeling of applied commercial lettering, and serves to prevent the formation of unsightly and difficult to remove black streaks that otherwise frequently form on the personal cargo compartment during exposed trailer storage, and wherein the cover is designed to accommodate trailers of a plurality of lengths and dimensional configurations.

More specifically, the present personal cargo utility trailer cover device preferably defines a rectangular box shape with an open bottom, with a rear panel partially attached via zipper or other appropriate means in order to allow access to the interior of the trailer without removal of the cover, and with an extended top or roof panel overhang to facilitate water runoff. The dimensional configuration of the device facilitates essentially universal adaptive fit for typical personal cargo utility trailers, generally 10 to 20 feet in length, and accommodates differing structural shapes and features of such trailers, as will be more specifically discussed below, yet maintains full height coverage for a typical personal cargo utility trailer, including wheels. Wheel well features are preferably provided, wherein the generally extended nature of the wheel wells relative to the side walls for many personal cargo utility trailers may be accommodated thereby. These wheel well features may comprise pleated or otherwise extendable regions for generally universal adaptation to a plurality of wheel well dimensions, and/or may comprise removable structural elements, such as “zip-off” wheel well cover components, in order to allow adaptable specialization of the otherwise universal utility trailer cover.

An incorporated transparent viewing window may be provided in one or more side panels of the cover to enable viewing of a logo or other lettering or artwork that may be displayed on the utility trailer. In such manner, the trailer may receive protection from the elements while parked during non-use without loss of the beneficial exploitation of the on-board advertising, wherein passers-by may continue to view same, such as when the trailer is strategically parked near a thoroughfare.

Further, one or more attachment straps may be incorporated to enable the cover to be completely secured from inadvertent removal, such as by gusty winds, wherein the strap(s) may extend underneath the utility trailer and fasten to the sides of cover. Elasticized corners may be provided, and/or fastenable straps, at each corner in order to facilitate a tight fit of the generally universal cover to a plurality of utility trailer dimensions. Additionally, while the cover is preferably economically manufactured from non-woven polypropylene fabric, the cover may be treated with any one of a plurality of protective coatings, such as a coating to the top or roof, or entirely thereover, to impart water resistive and/or repellant characteristics, and/or treatment to enhance ultraviolet endurance, and/or to minimize susceptibility to mold, mildew, or fire, such as via application of UV protectants, anti-microbials, anti-fungals, and/or fire resistants.

Thus, a feature and advantage of the present device is its ability to perform as a cost-effective integral unit, suitable for deployment on essentially any individual-use sized cargo utility trailer.

Another feature and advantage of the present device is its ability to perform as a customized cover by incorporation of removable and generally dimensionally-fitted component features, such as extended wheel well panels.

Yet another feature and advantage of the present device is its ability to provide complete barrier coverage from environmental elements without sacrificing viewable access to on-board visual displays, such as logos and lettering.

Still another feature and advantage of the present device is its ability to effectively perform on a plurality of personal cargo utility trailer designs and lengths, such as a PACE trailer and other trailers ranging generally from ten to twenty feet in length.

Yet still another feature and advantage of the present device is its ability to provide a “universal fit” to accommodate differing shapes, elements, and structural features of cargo utility trailers.

Still yet another feature and advantage of the present device is its ability to enable full body and length coverage for a cargo trailer, thereby preventing tire rot from sun exposure, unsightly and difficult to remove black streaks from storage soiling, and peeling of applied commercial lettering from constant exposure to the elements.

Still another feature and advantage of the present device is its ability to enable access to cargo held within the trailer without requiring removal of the cover therefrom.

Yet another feature and advantage of the present device is its ability to facilitate water runoff from the roof surface of a cargo utility trailer.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of an utility trailer cover, according to the preferred embodiment of the present device, showing the front end of a trailer, proximate the hitch, covered thereby, and showing an extended wheel well covered thereby;

FIG. 2 is a perspective rear view of the device of FIG. 1, showing a viewing window in the rear panel of the cover;

FIG. 3 is a perspective rear view of the device of FIG. 1, showing a the rear panel of the cover opened for access to the trailer interior;

FIG. 4 is a perspective view of an utility trailer cover, according to an alternate embodiment, showing a viewing window in a side panel of the cover, and showing a wheel well component; and

FIG. 5 is a perspective view of an utility trailer cover, according to an alternate embodiment, showing elasticized corners, corner ties, and securing straps.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

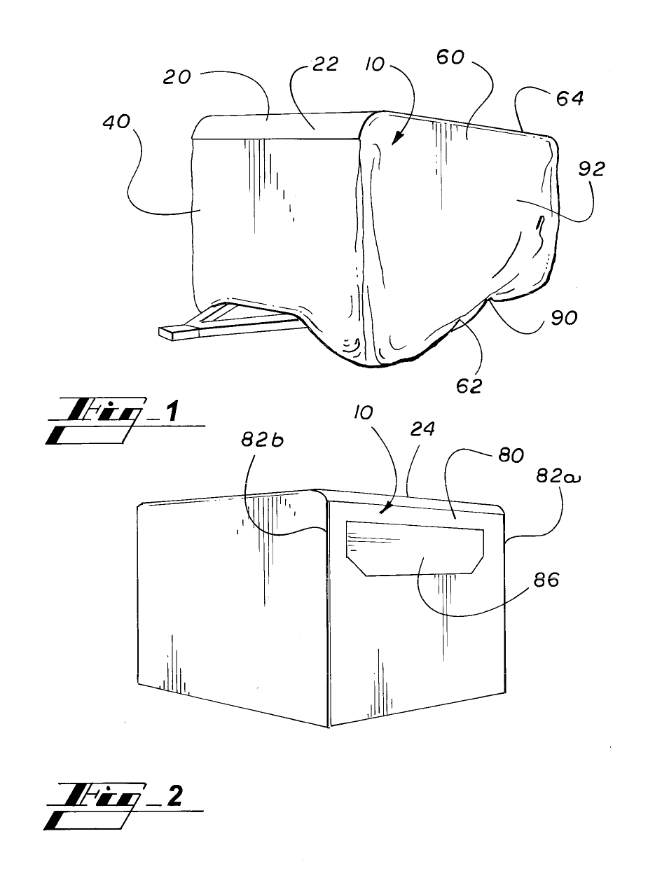

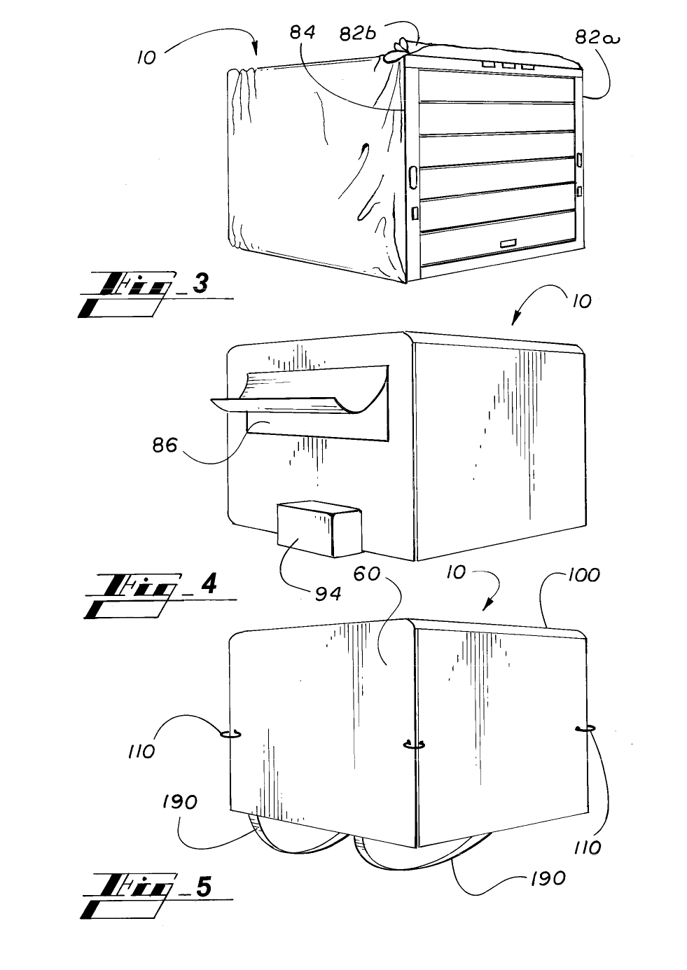

Referring now to FIGS. 1-5, cargo utility trailer cover device 10 preferably comprises roof panel 20, front panel 40, two opposingly positioned side panels 60, and rear panel 80, wherein the plurality of panels 20, 40, 60, 80 preferably define a generally rectangular box shape with an open bottom. This general shape facilitates universal adaptive fit of cover device 10 over essentially any typical personal cargo utility trailer, generally 10 to 20 feet in length. That is, cover device 10 is intended to satisfy the unmet need for personal utility trailer protection in an economically efficient fashion, by enabling cost-efficient mass production of a singularly shaped cover device 10 that may accommodate any one of a plurality of personal utility trailers, or that may be interchangeably deployed thereon, without compromise on performance and structural adaptivity.

Cover device 10 is preferably economically manufactured from non-woven polypropylene fabric. It should be noted that other materials may be utilized, in addition to and/or in lieu of non-woven polypropylene fabric, whether woven or non-woven, and whether fabric, synthetic or natural materials, wherein some characteristics, such as weight and life expectancy may be influenced thereby; however, suitably strong, lightweight, and inexpensive materials are preferred. Additionally, it should be noted that although cover device 10 is described and preferred as being formed from plurality of panels 20, 40, 60, 80, one skilled in the art should recognize that cover device could be integrally formed from more continuous subsections, or as a singular and seamless unit, as desired and as according to manufacturing preferences.

In the preferred embodiment, top panel 20 is generally elongated relative to the length of side panels 60, as is depicted generally in FIG. 1, such that top panel 20 defines roof overhang 22 to facilitate water runoff and to eliminate water collection along a seam line. Similar roof rear overhang 24 is preferably defined, as depicted in FIG. 2. Top panel 20 could alternately be constructed without roof overhang 22 and/or without roof rear overhang 24, with recognized loss of water runoff feature.

It is preferred that top panel 20 is at least water resistive, and is preferably water proof and water repellant, such as by coating and/or other treatment. Alternately, top panel 20 could be constructed from material having such characteristics, wherein no coating or treatment would be required. Further, the entirety of cover device 10 could be similarly coated and/or treated, and/or constructed from water proof and/or water repellant materials. Preferably, each panel 20, 40, 60, and 80 is chemically treated, according to known methods, to impart water resistive and/or repellant characteristics, as necessary, to enhance ultraviolet endurance, and to minimize susceptibility to mold, mildew, or fire, such as via application of known UV protectants, anti-microbials, anti-fungals, and/or fire resistants. Of course, any or all of these treatments may be applied to cover device 10, according to a plurality of embodiments, such as according to selection by geographic area, for example, and cost-benefit analysis for users.

In the preferred embodiment, rear panel 80 is adapted to facilitate access to the interior of a covered trailer, wherein rear panel 80 is preferably releasably attached to side panels 60 along edges 82a, 82b. The preferred means for releasable attachment 84 is a zipper (not shown), but any suitable means could be utilized, such as, for exemplary purposes only, hook and loop fastener, snaps, ties, elongate snap-lock tracks, or any other appropriate means for releasable attachment. Rear panel 80 is also preferably adapted with transparent viewing window 86, whereby a logo or other lettering, artwork or display on the rear door of a covered trailer may be seen therethrough. In such preferred manner, cover device 10 is able to serve as protection for the outer surfaces of a utility trailer without diminishing the potentially beneficial impact of any visual display thereon. It should be noted, as seen exemplarily in FIG. 4, viewing window 86 could alternately and/or additionally be defined on either or both side panels 60, as desired.

According to the preferred embodiment of cover device 10, the dimensions serve to accommodate differing structural shapes and features of typical utility trailers. For example, the overall length of side panels 60, rear panel 80 and front panel 40 is preferably sufficient to enable cover device 10 to fully cover a typical personal cargo utility trailer, including wheels, in order to provide protection to the trailer wheels and to prevent and/or at least retard tire rot. Because cover device 10 is intended to be a universal-fit device for use on any one of a plurality of utility trailers, and because known utility trailers may have extended wheel well fenders, wheel well features 90 are preferably included. In the simplest and most economical form, as is preferred, side walls 60 are defined with a generally polyhedral perimeter shape, wherein bottom edge 62 has a greater length than top edge 64, such that wheel well features 90 are defined as a generally extendable zone that may accommodate extended wheel well fenders at essentially any position along the length of cover device 10.

In the preferred method of use, cover device 10 is unfolded over a cargo utility trailer, with front panel 40 proximate the trailer hitch, rear panel 80 proximate the rear door, top panel 20 on the upper surface of the trailer, and sides extending along the length of the trailer unit. Preferably without necessity of any further adjustment, wheel well features 90 accommodate extended wheel well fenders and cover device 10 is positioned to extend, fully covering the trailer and wheels thereof. For access to interior, releasable side edges 82a, 82b of rear panel 80 are opened.

According to an alternate embodiment, wheel well features 90 may be more specifically located within the expanse of side panels 60, wherein pleats (not shown) may be defined for a more formal expansion zone proximate a wheel well, and/or wherein snaps, ties, or the like (also not shown) may be provided to allow for tightening the fit of the expansion zone about the wheel well. According to another alternate embodiment, exemplarily depicted in FIG. 4, wheel well features 90 may alternately be specifically dimensioned cover extensions 94, defined as generally box-shaped components. In such an embodiment, universal cover device 10 may be imparted with a more customized nature, yet without compromise on the economically beneficial overall design thereof, wherein each dimensioned cover extension 94 could be adapted for removable attachment proximate a defined opening in a side panel 60, such as via zippers, snaps, or the like. Cover device 10 could be manufactured with a plurality of generally flat removable wheel well panels (not shown) that could enable user selection for removal of one the plurality of removable wheel well panels to allow for extension of a wheel well fender through an opening defined thereby. In such manner, cover device 10 could be utilized to cover a utility trailer, with wheel well and wheels exposed, but could also rather be utilized as a singular, adaptable base that could allow for user selection of positioning for dimensioned cover extensions 94, according to particular trailer configurations.

Finally, in another alternate configuration, one or more straps 190 may be provided, as shown in FIG. 5, to extend underneath the utility trailer and secure side panels 60 to one another, further enchancing the security of deployed cover device 10, such as in gusty winds. If two straps 190 are utilized, beneficial placement would entail divided positioning proximate the front and rear of the utility trailer undercarriage.

Referring further to FIG. 5, another manner for enhancing adaptability of the universal fit of cover device 10 is shown, wherein plurality of elasticized corners 100 may be provided. In such manner, extension of elasticized corners 100 may allow for accommodation of more lengthy trailers, with smaller trailers more snugly fit without similar extension. Alternately, plurality of fastenable straps 110 could be provided in order to facilitate user adjustability of the deployed dimensions of cover device 10, wherein fastenable straps may be tied, snapped, or otherwise engaged to define a tight fit for the generally universal cover device 10 to a plurality of utility trailer dimensions.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A cover for a cargo utility trailer, comprising:
a rectangular shaped roof panel having a first elongate length;
two opposingly positioned side panels attached to said roof panel, each said side panel having a length less than said elongate length of said roof panel;
a front panel attached to said roof panel and to said two opposingly positioned side panels; and
a rear panel attached to said roof panel, and removably attached to said two opposingly positioned side panels,
wherein at least one of said panels further comprises a transparent portion.

2. The cover of claim 1, further comprising a removable wheel well cover structure.

3. A personal cargo utility trailer cover device, comprising:
a rectangular box shaped cover, said cover having an open bottom and a rear panel, wherein said rear panel is partially attached to said cover via releasable means, and wherein partial detachment of said rear panel from said cover facilitates access to the interior of the personal cargo utility trailer without necessitating removal of said cover from the trailer.

4. The personal cargo utility trailer cover device of claim 3, wherein said releasable means is selected from the group consisting of a zipper, snaps, ties, hook and loop fastener, pressure-channel lock fastener, and buttons.

5. The personal cargo utility trailer cover device of claim 3, wherein said cover further comprises a top panel opposingly positioned relative to said open bottom and a front panel opposingly positioned relative to said rear panel, and wherein installation of said cover on the personal cargo utility trailer positions said top panel on the roof of the trailer such that a first top panel extension segment of extends downwardly from said roof panel.

6. The personal cargo utility trailer cover device of claim 3, wherein said cover is dimensioned to fit a personal cargo utility trailer that is from ten to twenty feet in length, and wherein said cover extends over the personal cargo utility trailer, covering the wheels.

7. The personal cargo utility trailer cover device of claim 3, wherein said rectangular box shaped cover further comprises a first and a second side panel, and wherein said first and said second side panel each further comprise at least one generally extendable region adapted to cover an extended wheel well on the personal cargo utility trailer.

8. The personal cargo utility trailer cover device of claim 7, wherein said at least one generally extendable region is selected from the group consisting of a pleated wheel well region and a removable wheel well region.

9. The personal cargo utility trailer cover device of claim 8, wherein said at least one generally extendable region is said removable wheel well region, and wherein said removable wheel well region is a zip-off, prism-shaped element.

10. The personal cargo utility trailer cover device of claim 3, wherein said rectangular box shaped cover further comprises a first and a second side panel, and wherein one or more of said first and said second side panels, said front panel and said rear panel further comprises a transparent window for viewing trade advertisement displayed on the personal cargo utility trailer.

11. The personal cargo utility trailer cover device of claim 3, further comprising one or more attachment straps, wherein said one or more attachment straps removably attach to said rectangular box shaped cover, proximate said open bottom thereof, with a first end of any one of said one or more attachment straps attached in an opposing position relative to a second end of said one or more attachment straps, such that said one or more attachment straps may extend underneath the trailer.

12. The personal cargo utility trailer cover device of claim 3, wherein said rectangular box shaped cover further comprises a first and a second side panel and a plurality of elasticized corners, with at least one said elasticized corner defined at the connection of said first side panel and said front panel, of said second side panel and said front panel, of said first side panel and said rear panel, and of said second side panel and said rear panel.

13. The personal cargo utility trailer of claim 3, wherein said rectangular box shaped cover is manufactured from non-woven polypropylene fabric, is treated with a protective coating on at least a portion of one surface thereof.

14. The personal cargo utility trailer of claim 13, wherein said protective coating is selected from the group consisting of water resistive treatment, water repellant treatment, ultraviolet endurance treatment, anti-fungal, anti-microbial, and fire resistant treatment.

15. The personal cargo utility trailer of claim 3, wherein said rectangular box shaped cover is manufactured from material selected from the group consisting of woven and non-woven fabric, synthetic, and natural material.

16. The personal cargo utility trailer of claim 3, wherein said rectangular box shaped cover is a singular, integrally formed, and seamless unit.

17. The personal cargo utility trailer cover device of claim 5, wherein a dimensional length of said top panel dictates that a second top panel extension segment extends downwardly from said roof panel proximate said rear panel.

18. The personal cargo utility trailer cover device of claim 3, further comprising a roof panel constructed from materials that is at least water resistive.

19. The personal cargo utility trailer cover device of claim 3, further comprising a plurality of side walls, each said side wall defined with a generally polyhedral perimeter shape, wherein a bottom edge of each said side wall has a greater length than a top edge.

20. The personal cargo utility trailer cover device of claim 3, wherein said rectangular box shaped cover further comprises a plurality of corners, with at least one fastenable strap positioned proximate each said corner of said plurality, said fastenable strap adapted to tighten said cover relative to the personal cargo utility trailer.
